(19) United States
(12) Patent Application Publication
(10) Pub. No.: US 2021/0006919 A1
(43) Pub. Date: Jan. 7, 2021

(54) AUDIO SIGNAL PROCESSING APPARATUS, AUDIO SIGNAL PROCESSING METHOD, AND NON-TRANSITORY COMPUTER-READABLE RECORDING MEDIUM

(71) Applicant: Clarion Co., Ltd., Saitama-shi (JP)

(72) Inventor: Yuki KASHINA, Saitama (JP)

(73) Assignee: Clarion Co., Ltd., Saitama-shi (JP)

(21) Appl. No.: 16/919,338

(22) Filed: Jul. 2, 2020

(30) Foreign Application Priority Data
Jul. 4, 2019 (JP) 2019-125186

(51) Int. Cl. H04S 7/00

(52) U.S. Cl. CPC H04S 7/30; H04S 2400/13

(57) ABSTRACT

There is provided an audio signal processing apparatus including a adjusting circuit configured to adjust an acoustic transfer function obtained based on an arrival sound, which is collected by a sound collector, arrived from a direction which forms a particular angle to the sound collector, the adjusting circuit adjusting the acoustic transfer function by applying a process to an amplitude spectrum of the acoustic transfer function, the process including more amplifying a frequency component having an amplitude of the amplitude spectrum is greater than a particular reference level and more attenuating a frequency component having an amplitude of the amplitude spectrum is less than the particular reference level, and a processing circuit configured to add, to the audio signal, information indicating an arrival direction of a sound based on the acoustic transfer function.

### CROSS-REFERENCE TO RELATED APPLICATIONS

This application claims priority under 35 U.S.C. § 119 from Japanese Patent Application No. 2019-125186 filed on Jul. 4, 2019. The entire subject matter of the application is incorporated herein by reference.

### BACKGROUND

### Technical Field

The present disclosures relate to an audio signal processing apparatus, an audio signal processing method, and a non-transitory computer-readable recording medium.

### Related Art

There has been known a technique for localizing a sound image by convolving an acoustic transfer function into an audio signal of a sound, such as a human voice or a music, and adding information on an arrival direction of the sound (in other words, a position of a sound image) to the audio signal.

The conventional audio signal processing apparatus is configured to store a plurality of acoustic transfer functions respectively corresponding to different arrival directions. Each acoustic transfer function contains information of a spectral cue, which is a characteristic part of the frequency characteristic (e.g., peaks or notches on a frequency domain) that provides a listener to sensing sound localization. A lot of the spectral cues are present in a high frequency region. The conventional audio signal processing apparatus is configured to synthesize the acoustic transfer functions corresponding to a plurality of arrival directions and convolve the synthesized acoustic transfer function into the audio signal so as to simulate sound image localization by a plurality of virtual speakers and weaken sound image localization by a real speaker.

### SUMMARY

In the conventional technique, a pair of speakers is arranged behind the head of the listener. In such a listening environment, when an audio signal, to which information on the arrival direction is added by convolving therein an acoustic transfer function of a sound output from a virtual speaker, is played, a played sound reaches the listener without correctly reproducing a large part of the spectral cues of the sound output from the virtual speaker because the higher the frequency region is, the easier the phase of the audio signal is shifted.

The above-mentioned phase shift will be described below further. Given that there are two cases: a case 1 and a case 2. In the case 1, it is assumed that two speakers arranged on front-right and front-left sides of the listener's head, respectively, while, in the case 2, it is assumed that two speakers are arranged on rear-right and rear left sides of the listener's head, respectively. In the case 2, an earlobe of the listener is positioned on a propagation path of the sound output from each speaker. The higher the frequency of the sound is, the shorter the wavelength is, and the greater the influence of diffraction and absorption of the sound by the earlobe are. In particular, the phase shift in crosstalk paths (i.e., a path between the left speaker and the right ear and a path between the right speaker and the left ear) becomes larger in the case 2 than in the case 1. Further, in the case 2, as compared with the case 1, the amount of phase shift varies nonlinearly on the frequency axis. In the case 2 corresponding to the conventional technique, due to a large phase shift in the high frequency range, in combination with the non-linear phase shift on the frequency axis, it is difficult to correctly reproducing of the spectral cue, and it is difficult to obtain desired sound image localization.

According to aspects of the present disclosure, there is provided an audio signal processing apparatus an audio signal processing apparatus configured to process an audio signal including adjusting circuit configured to adjust an acoustic transfer function obtained based on an arrival sound, which is collected by a sound collector, arrived from a direction which forms a particular angle to the sound collector, the adjusting circuit adjusting the acoustic transfer function by applying an emphasizing process to an amplitude spectrum of the acoustic transfer function, the emphasizing process including amplifying an amplitude component of the amplitude spectrum more as an amplitude is greater than a particular reference level and attenuating the amplitude component of the amplitude spectrum more as the amplitude is smaller than the particular reference level, and a processing circuit configured to add, to the audio signal, information indicating an arrival direction of a sound based on the acoustic transfer function adjusted by the adjusting circuit.

According to aspects of the present disclosure, there is provided an audio signal processing apparatus configured to process an audio signal including a adjusting circuit configured to adjust an acoustic transfer function obtained based on an arrival sound, which is collected by a sound collector, arrived from a direction which forms a particular angle to the sound collector, the adjusting circuit adjusting the acoustic transfer function by emphasizing a peak and a notch of a spectral cue represented in an amplitude spectrum of the acoustic transfer function, and a processing circuit configured to add, to the audio signal, information indicating an arrival direction of a sound based on the acoustic transfer function adjusted by the adjusting circuit.

According to aspects of the present disclosure, there is provided an audio signal processing method for an audio signal processing apparatus configured to process an audio signal, including adjusting an acoustic transfer function obtained based on an arrival sound, which is collected by a sound collector, arrived from a direction which forms a particular angle to the sound collector, the acoustic transfer function being adjusted by applying an emphasizing process to an amplitude spectrum of the acoustic transfer function, the emphasizing process including amplifying an amplitude component of the amplitude spectrum more as an amplitude is greater than a particular reference level and attenuating the amplitude component of the amplitude spectrum more as the amplitude is smaller then the particular reference level, and adding, to the audio signal, information indicating an arrival direction of a sound based on the adjusted acoustic transfer function.

According to aspects of the present disclosure, there is provided a non-transitory computer recording medium for causing an audio signal processing apparatus, the recording medium containing computer-executable programs causing, when executed by a computer, the audio signal processing apparatus to perform the above described audio signal processing method.

### BRIEF DESCRIPTION OF THE ACCOMPANYING DRAWINGS

FIG. 1 is a schematic diagram showing inside car in which An audio signal processing apparatus according to a present embodiment of the present disclosures is installed.

FIG. 2 is a block diagram showing a configuration of an audio signal processing apparatus according to the present embodiment.

FIG. 3A is a graph for explaining operation of the reference information extracting circuit provided in the audio signal processing apparatus according to the present embodiment.

FIG. 3B is a graph for explaining operation of the reference information extracting circuit provided in the audio signal processing apparatus according to the present embodiment.

FIG. 3C is a graph for explaining operation of the reference information extracting circuit provided in the audio signal processing apparatus according to the present embodiment.

FIG. 4A a graph showing a reference spectrum output from an FFT circuit provided in the audio signal processing apparatus according to the present embodiment.

FIG. 4B a graph showing the reference spectrum output from the FFT circuit provided in the audio signal processing apparatus according to the present embodiment.

FIG. 5A is a graph showing the reference spectrum output from the FFT circuit according to the present embodiment.

FIG. 5B is a graph showing the reference spectrum output from the FFT circuit according to the present embodiment.

FIG. 6A is a graph showing the reference spectrum output from the generating circuit provided in the audio signal processing apparatus according to the present embodiment.

FIG. 6B is a graph showing the reference spectrum output from the generating circuit provided in the audio signal processing apparatus according to the present embodiment.

FIG. 7A is a graph showing n amplitude spectrum of a first reference spectrum in a case where azimuth angle is 40° and elevation angle is 0°.

FIG. 7B is a graph showing an amplitude spectrum of a second reference spectrum in the case where azimuth angle is 40° and elevation angle is 0°.

FIG. 7C is a graph showing an amplitude spectrum of a reference spectrum in the case where azimuth angle is 40° and elevation angle is 0°.

FIG. 7D is a graph showing an amplitude spectrum of a reference spectrum of an measured impulse response in the case where azimuth angle is 40° and elevation angle is 0°.

FIG. 7E is a graph showing difference between the amplitude spectrum shown in FIG. 7C and the amplitude spectrum shown in FIG. 7D.

FIG. 8A is a graph showing an amplitude spectrum of a reference spectrum in a case where distance between an output position of a sound and a listener is 0.50 m.

FIG. 8B is a graph showing an amplitude spectrum of a second reference spectrum in the case where distance between an output position of a sound and a listener is 0.50 m.

FIG. 8C is a graph showing an amplitude spectrum of a reference spectrum in the case where distance between an output position of a sound and a listener is 0.50 m.

FIG. 8D is a graph showing an amplitude spectrum of a reference spectrum of an measured impulse response in the case where distance between a output position of a sound and a listener is 0.50 m.

FIG. 8E is a graph showing difference between the amplitude spectrum shown in FIG. 8C and the amplitude spectrum shown in FIG. 8D.

FIG. 9A is a graph showing a criterion spectrum obtained by an emphasizing circuit, which is provided in the audio signal processing apparatus according to the present embodiment, adjusting the reference spectrum indicated in FIGS. 6A and 6B.

FIG. 9B is a graph showing a criterion spectrum obtained by an emphasizing circuit, which is provided in the audio signal processing apparatus according to the present embodiment, adjusting the reference spectrum indicated in FIGS. 6A and 6B.

FIG. 10A is a graph showing an example of a criterion spectrum.

FIG. 10B is a graph showing an example of the criterion spectrum.

FIG. 10C is a graph showing an example of the criterion spectrum.

FIG. 11A is a graph showing a criterion convolving filter obtained by a sound image area controller, which is provided in the audio signal processing apparatus according to the present embodiment, processing the criterion spectrum indicated in FIGS. 10A-10C.

FIG. 11B is a graph showing the criterion convolving filter obtained by a sound image area controller, which is provided in the audio signal processing apparatus according to the present embodiment, processing the criterion spectrum indicated in FIGS. 10A-10C.

FIG. 11C is a graph showing the criterion convolving filter obtained by a sound image area controller, which is provided in the audio signal processing apparatus according to the present embodiment, processing the criterion spectrum indicated in FIGS. 10A-10C.

FIG. 12A is a graph showing the criterion convolving filter obtained by the sound image area controller according to the present embodiment processing the reference spectrum shown in FIG. 10.

FIG. 12B is a graph showing the criterion convolving filter obtained by the sound image area controller according to the present embodiment processing the reference spectrum shown in FIG. 10.

FIG. 12C is a graph showing the criterion convolving filter obtained by the sound image area controller according to the present embodiment processing the reference spectrum shown in FIG. 10.

FIG. 13A is a graph showing the criterion convolving filter obtained by the sound image area controller according to the present embodiment processing the reference spectrum shown in FIG. 9.

FIG. 13B is a graph showing the criterion convolving filter obtained by the sound image area controller according to the present embodiment processing the reference spectrum shown in FIG. 9.

FIG. 14 a flowchart showing processes performed by a system controller provided in the audio signal processing apparatus in the present embodiment.

### DETAILED DESCRIPTION OF THE EMBODIMENT

Illustrative Embodiments of the present disclosures will be described below with reference to the accompanying drawings. Hereinafter, an audio signal processing apparatus 1 installed in a car will be described as an illustrative embodiment of the present disclosures. The audio signal processing apparatus 1 according to the present disclosures does not need to be limited to one installed in a car.

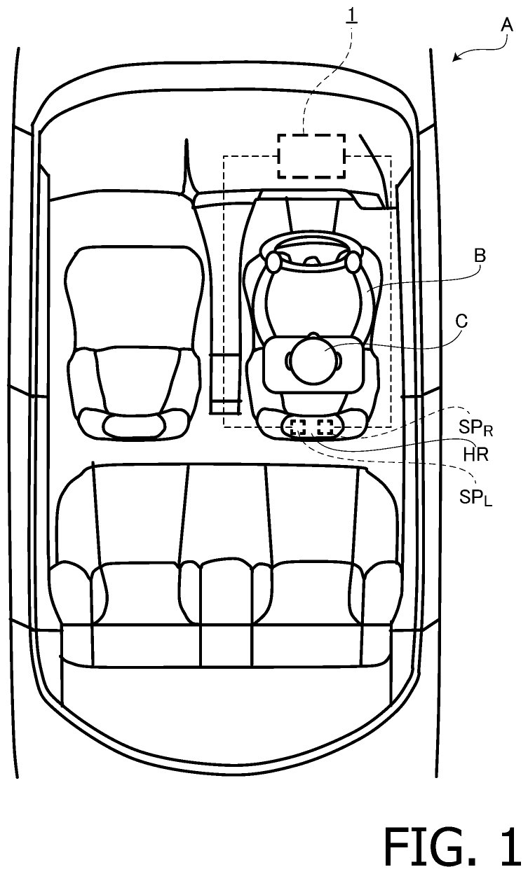

FIG. 1 is a schematic diagram showing inside of a car A in which an audio signal processing apparatus 1 according to an embodiment of the present disclosures is installed. In FIG. 1, for convenience of description, a head C of a passenger B seated in a drive's seat is shown.

As shown in FIG. 1, a pair of speakers SP_{L} and SP_{R} are embedded in a headrest HRs installed in the drivers seat. The speaker SP_{L} is located on the left back side with respect to the head C, and the speaker SP_{R} is located on the right back side with respect to the head C. Although FIG. 1 illustrates the speakers SP_{L} and SP_{R} installed in the headrest HR of the driver's seat, these speakers SP_{L} and SP_{R} may be installed in the headrest of another seat.

The audio signal processing apparatus 1 is a device for processing an audio signal input from a sound source device configured to output an audio signal, and is arranged, for example, in a dashboard of the car. The sound source device is, for example, a navigation device or an onboard audio device.

The audio signal processing apparatus 1 is configured to adjust an acoustic transfer function, which corresponds to a arrival direction of a sound to be simulated, by performing processing to emphasize a peak and a notch of a spectral cue appearing in an amplitude spectrum of the acoustic transfer function. The audio signal processing apparatus 1 performs a crosstalk cancellation process after adding information on the arrival direction of the sound to the audio signal based on the adjusted acoustic transfer function. Thus, when the information of the arrival direction added to the audio signal indicates a diagonally upward direction in the front right side, the passenger B perceives the sound output from the speaker SP_{L} and SP_{R} as a sound arrived from a diagonally upward direction in the front right side.

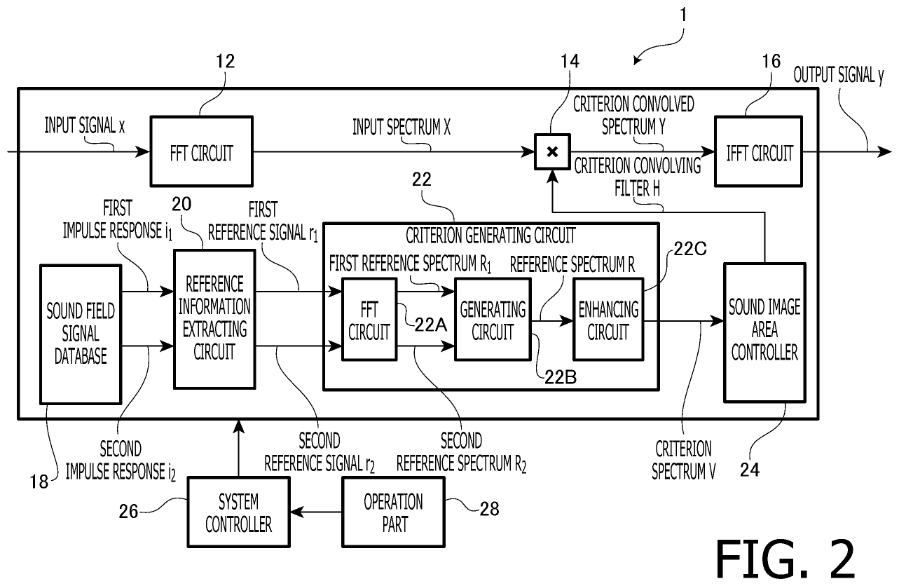

FIG. 2 is a block diagram showing a configuration of an audio signal processing apparatus 1. As shown in FIG. 2, the audio signal processing apparatus 1 includes an FFT (Fast Fourier Transform) circuit 12, a multiplying circuit 14, an IFFT (Inverse Fast Fourier Transform) circuit 16, a sound field signal database 18, a reference information extracting circuit 20, a criterion generating unit 22, a sound image area controller 24, a system controller 26, and an operation part 28.

It is noted that the audio signal processing apparatus 1 may be an apparatus separate from the navigation device and the onboard audio device, or may be a DSP mounted in the navigation device or onboard audio device. In the latter case, the system controller 26 and the operation part 28 is provided in the navigation device or the onboard audio device, not in the audio signal processing apparatus 1 being a DSP.

The FIT circuit 12 is configured to convert the audio signal in a time domain (hereinafter, referred to as “input signal x” for convenience) input from the sound source device into an input spectrum X a frequency domain by Fourier transform processing, and outputs the input spectrum X to the multiplying circuit 14.

Thus, the FFT circuit 12 operates as a transforming circuit configured to apply Fourier transform to the audio signal.

The multiplying circuit 14 is configured to convolve the criterion convolving filter H input from the sound image area control section 24 into the input spectrum X input from the FFT circuit 12, and output a criterion convolved spectrum Y obtained by the convolution to IFFT circuit 16. By this convoluting process, the information of the arrival direction of the sound is added to the input spectrum X.

The IFFT circuit 16 is configured to transform the criterion convolved spectrum Y in a frequency domain, which is input from the multiplying circuit 14, to an output signal y in a time domain by an inverse Fourier transform process, and output the output signal y to subsequent circuits. In the present embodiment, the Fourier transform process by the FFT circuit 12 and the inverse Fourier transform process by the IFFT circuit 16 are performed by Fourier transform length of 8192 samples.

The circuits at the subsequent stage of the IFFT circuit 16 are, for example, circuits included in the navigation device or the onboard audio device, and configured to perform known processes such as a crosstalk cancellation process on the output signal y inputted from the IFFT circuit 16, and output the output signal y to the speakers SP_{L} and SP_{R}. Thus, the passenger B perceives the sound output from the speakers SP_{L} and SP_{R} as a sound arrived from the direction simulated by the audio signal processing apparatus 1.

The criterion convolving filter H output from the sound image area controller 24 is an acoustic transfer function for adding the information of the arrival direction of the sound, which is to be simulated, to the audio signal. A series of processes up to the generation of the criterion convolving filter H will be described in detail below.

There has been known a systems for measuring an impulse response. In this type of system, a dummy head mounting a microphone (referred to as a “dummy head microphone” for convenience) simulating a human face, an car, a head, a torso, or the like is arranged in a measurement room, and a plurality of speakers are located so as to surround the dummy head microphone from right to left or up and down by 360 degrees (for example, on a spherical locus centered on the dummy head microphone). Respective speakers constituting the speaker array are located at intervals of, for example, 30° in azimuth angle and elevation angle with reference to the position of the dummy head microphone. Each speaker can move on a trajectory of the spherical locus centered on the dummy head microphone and can also move in a direction approaching or spaced apart from the dummy head microphone.

The sound field signal database 18 stores, in advance, multiple impulse responses obtained by sequentially collecting the sound output from each speaker constituting the speaker array (in other words, the arrival sound from a direction forming a predetermined angle, that is, an azimuth angle and an elevation angle with respect to the dummy head microphone which is a sound pickup unit) by the dummy head microphone in the above system. That is, the sound field signal database 18 stores, in advance, multiple impulse responses of a plurality of arrival sounds-which are arrived from different directions. In the present embodiment, multiple impulse responses of multiple sounds arrival from directions of which the azimuth angle and the elevation angel of the arrival direction are different by 30 degrees, respectively, are stored in advance. The sound field signal database 18 may have a storage area, and multiple impulse responses may be stored in the storage area.

In the above system, each speaker is moved in a direction approaching or spaced from the dummy head microphone, and the impulse response of the sound output from each speaker of each position after the movement (in other words, for each distance between the speaker and the dummy head microphone) is measured. The sound field signal database 18 stores, for each arrival direction, the impulse response at each distance (e.g., 0.25 m, 1.0 m . . . ) between the speaker and the dummy head microphone. That is, the sound field signal database 18 stores multiple impulse responses of multiple sounds, and a distance of each sound between an outputting position of the sound (i.e., each speaker) and a collecting position (i.e., the dummy head microphone) is different.

In this manner, the sound field signal database 18 operates as a storing part that stores the impulse response of the arrival sound, more specifically, data indicating the impulse response.

In the present embodiment, it is assumed that the input signal x includes meta information indicating the arrival direction of the sound and the distance between the output position of the sound and the listener (in the present embodiment, the arrival direction to be simulated and the propagation distance to be simulated from the outputting position of the sound and to head C of the passenger B when the passenger B is seated in the driver's seat). The sound field signal database 18 outputs at least one impulse response based on the meta information included in the input signal x under the control by the system controller 26.

As an example, a case where the arrival direction to be simulated is “the azimuth angle 40°, the elevation angle 0°” will be explained below. The sound field signal database 18 does not store the impulse response of the sound arrived from this arrival direction (i.e., from a direction of the azimuth angle 40° and the elevation angle 0°). The sound field signal database 18 outputs an impulse response corresponding to a pair of speakers sandwiching this arrival direction, that is, an impulse response corresponding to “azimuth angle 30°, elevation angle 0°” and an impulse response corresponding to “azimuth angle 60°, elevation angle 0°” in order to simulate the impulse response (in other words, an acoustic transfer function) corresponding to the arrival direction. Hereinafter, the output two impulse responses are referred to as a “first impulse response i₁” and a “second impulse response i₂” for convenience. Incidentally, when the arrival direction to be simulated is, for example, “azimuth angle 30° and elevation angle 0°,” the sound field signal database 18 outputs only the impulse response corresponding to “azimuth angle 30°, elevation angle 0°.”

In another embodiment, the sound field signal database 18 may output three or more impulse responses each of which corresponding to a arrival direction close to “azimuth 40°, elevation 0°” in order to simulate the impulse response corresponding to “azimuth 40°, elevation 0°.”

The impulse response output from the sound field signal database 18 may be arbitrarily set by a listener (e.g., the passenger B) by an operation on the operation part 28, or may be automatically set by the system controller 26 in accordance with a sound field set in the navigation device or the onboard audio device. For example, the arrival direction or the propagation distance to be simulated may be arbitrarily set by the listener or may be automatically set by the system controller 26.

The spectral cues (e.g., notches or peaks on the frequency domain) appearing in the high frequency range of a head-related transfer function included in the acoustic transfer function are known as characteristic parts that provide clues for the listener to sense the sound image localization. The patterns of notches and peaks are said to be determined primarily by auricles of the listener. The effect of the auricles is thought to be mainly included in an early part of the head-related impulse response, because of its positional relationship with the observation point (i.e., an entrance of an external auditory meatus). For example, a non-patent document 1 (K. Iida, Y. Ishii, and S. Nishioka: Personalization of head-related transfer functions in the median plane based on the anthropometry of the listener's pinnae, J Acoust. Soc. Am., 136, pp. 317-333 (2014)) discloses a method of extracting notches and peaks, which are spectral cues, from an early part of a head-related impulse response.

The reference information extracting circuit 20 extracts, by the method described in the non-patent document 1, reference information for extracting notches and peaks, which are spectral cues, from the impulse response input from the sound field signal database 18.

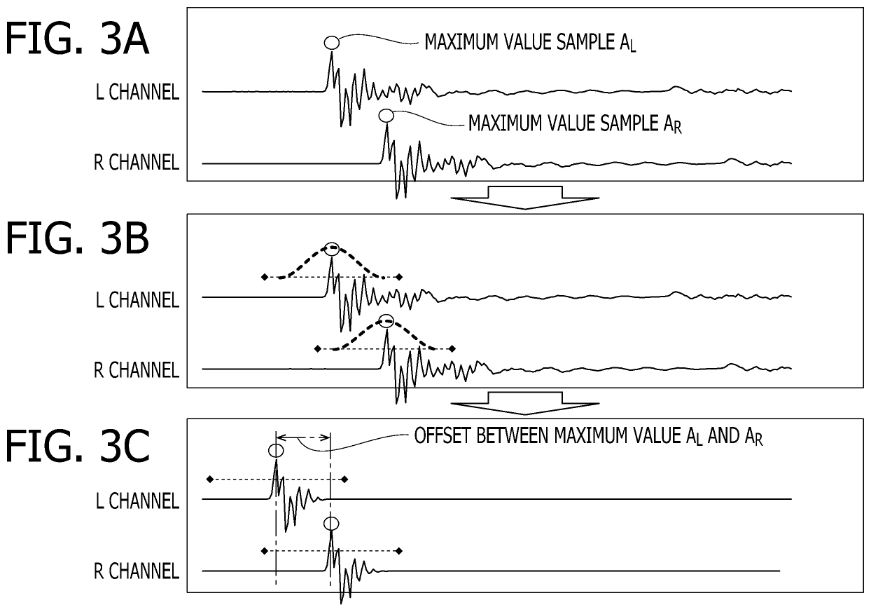

FIGS. 3A-3C are graphs for explaining the operation of the reference information extracting circuit 20. In FIGS. 3A-3C, the vertical axis of each graph indicates an amplitude, and the horizontal axis indicates time. It is noted that FIGS. 3A-3C are a schematic diagram for explaining the operation of the reference information extracting circuit 20, and therefor units of the respective axes are not shown.

The reference information extracting circuit 20 is configured to detect a maximum values of the amplitudes of a first impulse response i₁ and a second impulse response i₂, which are the acoustic transfer functions including the head-related transfer functions. More specifically, the reference information extracting circuit 20 is configured to detect a maximum value of the amplitude of the first impulse response i₁ of each of the L channel and the R channel and detect a maximum value of the amplitude of the second impulse response i₂ of each of the L channel and the R channel. The graph shown in FIG. 3A indicates a maximum value sample A_{R} in which the first impulse response i₁ of the R channel has a maximum value and a maximum value sample A_{L} in which the first impulse response i₁ of the L channel has a maximum value, which are detected by the reference information extracting circuit 20.

The reference information extracting circuit 20 performs the same process on the first impulse response i₁ and the second impulse response i₂. In the following, the process for the first impulse response i₁ will be described, and the process for the second impulse response i₂ will be omitted.

The reference information extracting circuit 20 is configured to clip the first impulse response i₁ of the L channel and the first impulse response i₁ of the R channel while matching a center of the Blackman-Harris window of the fourth order and 96 points to time of each of the maximum value samples A_{L} and A_{R}. Thus, the first impulse response it is windowed by the Blackman-Harris window. The reference information extracting circuit 20 generates two arrays of 512 samples in which all values is zero, superimposes the clipped first impulse response i₁ of the L channel on one of the arrays, and superimposes the clipped first impulse response i₁ of the R channel on the other array. At this time, the first impulse response i₁ of the L channel and the first impulse response i₁ of the R channel are superimposed on the arrays so that the maximum value samples A_{L} and A_{R} are positioned at center samples (i.e., 257th samples) of two arrays, respectively. The graph shown in FIG. 3B indicates the first impulse responses i₁ of the 1 and R channels, and a range of effect (linear dashed line) and the amount of effect (mound-shape dashed line) of the windowing by the Blackman-Harris window.

By performing the above processing (i.e., windowing and shaping to have 512 samples), the first impulse responses i₁ are smoothed. The smoothing of the first impulse responses i₁ (and the second impulse responses i₂) contribute to improving the sound quality.

It is noted that there is a time difference (in other words, an offset) between the audio signal of the L channel and the audio signal of the R channel. In order to retain the information indicating this time difference (in the present embodiment, the time difference between the time of the maximum value sample A_{L} and the time of the maximum value sample A_{R}), zero padding is applied to the impulse responses so as to have 8192 samples of information. Hereinafter, for convenience, the first impulse response i₁, to which the zero padding is applied, of the L channel superimposed on the array is referred to as a “first reference signal r₁” and the first impulse response, to which the zero padding is applied, of the R channel superimposed on the array is referred to as a “second reference signal r₂.” The graph of FIG. 3C indicates the first reference signal r₁ and the second reference signal r₂.

The criterion generating circuit 22 includes an FFT circuit 22A, a generating circuit 22B and an emphasizing circuit 22C.

The FFT circuit 22A is configured to transform, by a Fourier transform process each of the first reference signal r₁ and the second reference signal r₂, which are time domain signals, inputted from the reference information extracting circuit 20 to a first reference spectrum R₁ and a second reference spectrum R₂ which are the frequency domain signals, respectively, and output the transformed signals to the generating circuit 22B.

The reference information extracting circuit 20 and the FFT circuit 22A operate as an obtaining circuit that acquires an acoustic transfer function including a spectral cue from an impulse response.

The generating circuit 22B generates a reference spectrum R by weighting each of the first reference spectrum R₁ and the second reference spectrum R₂ input from the FFT circuit 22A and synthesizing the weighted first reference spectrum R₁ and the weighted second reference spectrum R₂. More specifically, the generating circuit 22B acquires the reference spectrum R by performing the processing represented by the following equation (1). In the following equation (1), α is a coefficient, and X is a common component of the first reference spectrum R₁ and the second reference spectrum R₂.

$$R = ( 1 - {α}^{2} ) ( {R}_{1} - X ) + {α}^{2} ( {R}_{2} - X ) + X \\ where \\ 0 \leq α \leq 1 \\ X = \sqrt{\overline{{R}_{1}} ∘ {R}_{2}} \qquad ( 1 )$$

It is noted that, in the above equation (1), a notation indicating a frequency point is omitted. In practice, the generating circuit 22B obtains the reference spectrum R by calculating the value R for each frequency point using the above equation (1).

According to the above equation (1), the first reference spectrum R₁ (more specifically, the component obtained by subtracting the common component with the second reference spectrum R₂ from the first reference spectrum R₁) is weighted by the coefficient (1−α²), and the second reference spectrum R₂ (more specifically, the component obtained by subtracting the common component with the first reference spectrum R₁ from the second reference spectrum R₂) is weighted by the coefficient α². The coefficients by which respective referenced spectra are multiplied are not limited to (1−α²) and α², but may be replaced by other coefficients whose sum is equal to 1. Examples of these coefficients are (1−α) and α.

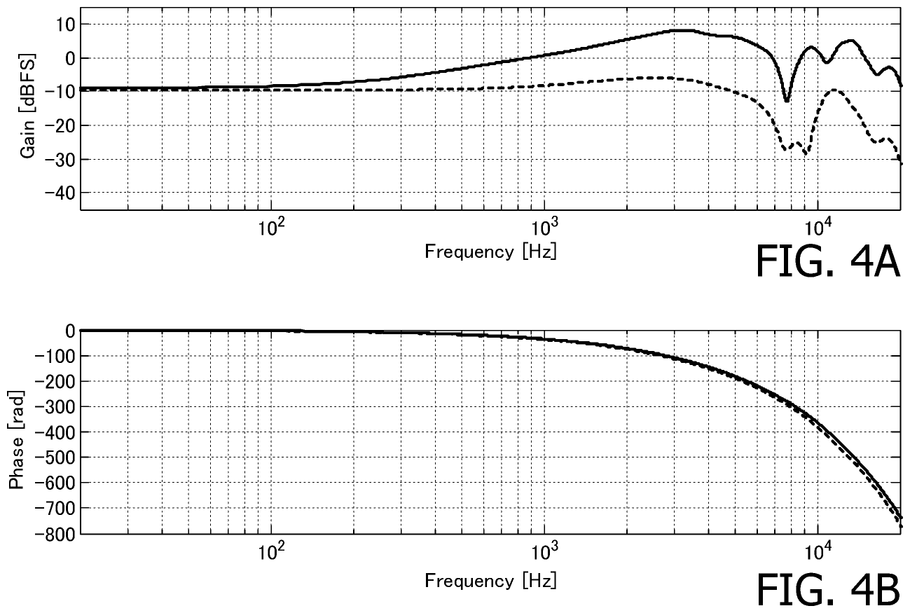

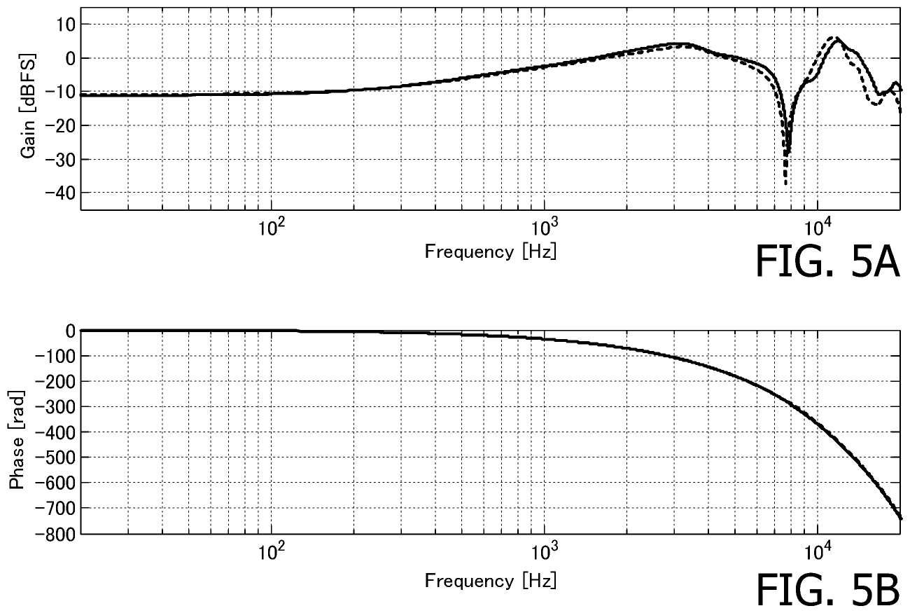

FIGS. 4A-4B, FIGS. 5A-5B, and FIGS. 6A-6B are graphs showing the frequency characteristics of the first reference spectrum R₁, the second reference spectrum R₂, and the reference spectrum R, respectively. FIGS. 4A, 5A and 6A show amplitude spectra, and FIGS. 4B, 5B and 6B show phase spectra. The vertical axis of each amplitude spectrum graph indicates power (unit: dBFS), and the horizontal axis indicates frequency (unit: Hz). The power of the vertical axis is power with a full scale of 0 dB. The vertical axis of each phase spectrum indicates phase (unit: rad), and the horizontal axis shows frequency (unit: Hz). In each of FIGS. 4A to 6B, the solid line indicates the characteristic of the L channel, and the broken line indicates the characteristic of the R channel. In the example of FIGS. 4A to 6B, the coefficient α is set to 0.25. In the following graphs, the solid line indicates the characteristic of the L channel, and the broken line indicates the characteristic of the R channel.

The coefficient α (and the coefficient β, the gain factor γ, the cutoff frequency fc described later) may be arbitrarily set by the listener by the operation on the operation unit 28, or may be automatically set by the system controller 26 according to the arrival direction to be simulated or the distance to be simulated between the output position and the listener.

In the present embodiment, the reference spectrum R can be adjusted by changing the coefficient α.

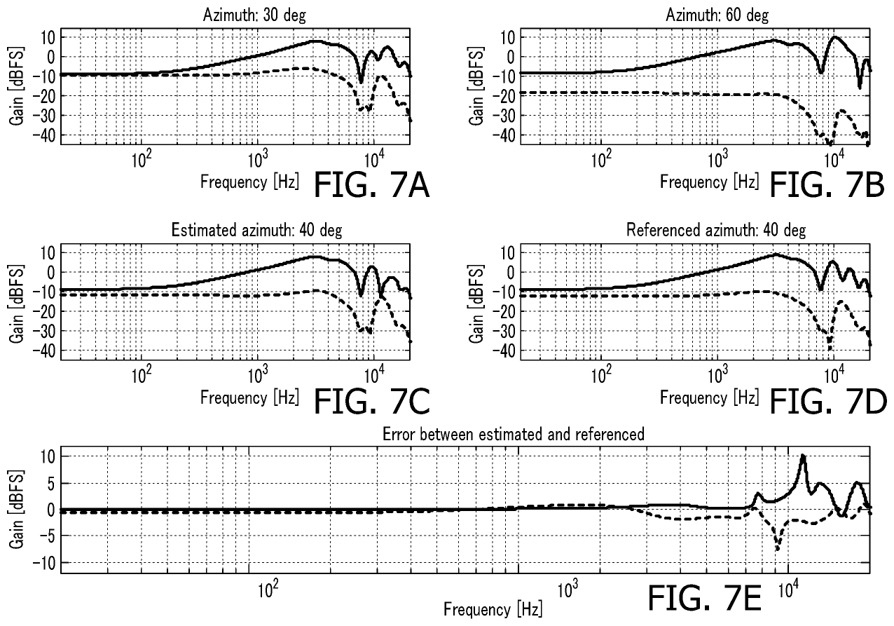

FIGS. 7A-7E shows specific examples of the first reference spectrum R₁, the second reference spectrum R₂, and the reference spectrum R when the arrival directions to be simulated are “azimuth angle 40°, elevation angle 0°” and the first reference spectrum R₁ and the second reference spectrum R₂ correspond to “azimuth angle 30°, elevation angle 0°,” “azimuth angle 60°, elevation angle 0°,” respectively.

FIGS. 7A and 7B show the amplitude spectrum of the first reference spectrum R₁ and the amplitude spectrum of the second reference spectrum R₂, respectively. FIG. 7C shows the amplitude spectrum of the reference spectrum R (i.e., an estimated amplitude spectrum of the reference spectrum R) simulating the “azimuth angle 40°, elevation angle 0°” acquired by the above equation (1). The coefficient α used in the calculation of the reference spectrum R is 0.5774. FIG. 7D shows the amplitude spectrum of the reference spectrum R acquired from the impulse response (actual measurement value) of “azimuth angle 40°, elevation angle 0°.” it is noted that the reference spectra shown in FIGS. 7A-7E are spectra of which the distance from the output position to the listener are the same.

FIG. 7E shows difference between the graph of FIG. 7C (i.e., the estimated amplitude spectrum of the reference spectrum R) and the graph of FIG. 7D (i.e., the actual measurement of the amplitude spectrum of the reference spectrum R). As shown in the graph of FIG. 7E, the estimated value (FIG. 7C), although errors with respect to the actual measurement value (FIG. 7D) in the high-frequency range is large, as a whole has a value close to the actual measurement value (FIG. 7D), and the pattern shapes of peaks or notches are relatively faithfully reproduced. Therefore, it can be said that the amplitude spectrum in the arrival direction to be simulated is accurately estimated in FIG. 7C.

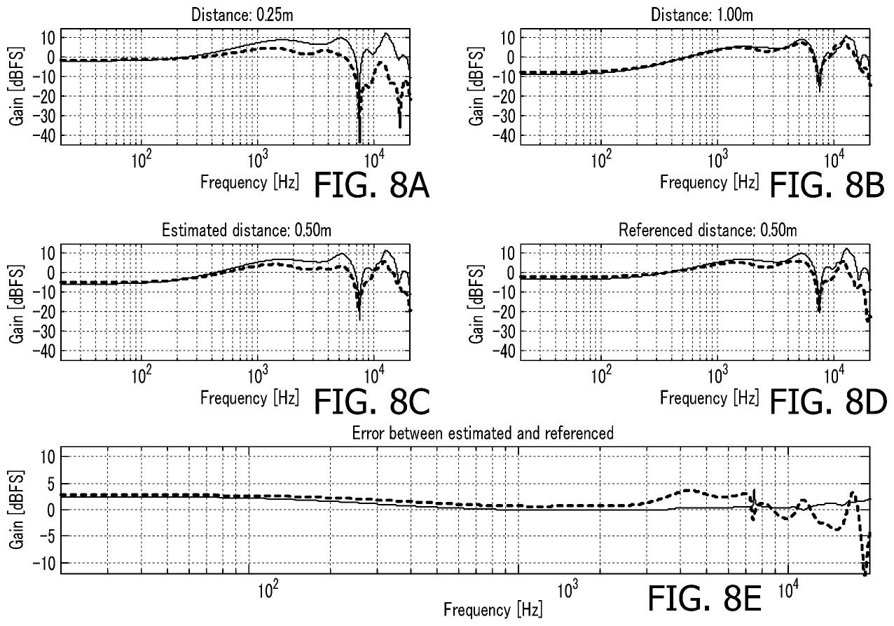

FIGS. 8A-8E shows specific examples of the first reference spectrum R₁, the second reference spectrum R₂, and the reference spectrum R when the distance to be simulated between the output position of the sound and the listener is “0.50 m” and the first reference spectrum R₁ and the second reference spectrum R₂ correspond to “0.25 m” and “1.00 m”, respectively.

The graphs in FIGS. 8A and 8B show the amplitude spectrum of the first reference spectrum R₁ and the amplitude spectrum of the second reference spectrum R₂, respectively. FIG. 8C shows the amplitude spectrum of the reference spectrum R simulating “0.50 m” acquired by the above equation (1) (i.e., an estimated amplitude spectrum of the reference spectrum R). The coefficient α used in the calculation of the reference spectrum R is 0.8185. The graph of FIG. 8D shows the amplitude spectrum of the reference spectrum R acquired from the impulse response (actual measurement value) of “0.50 m”, it is noted that the reference spectra shown in FIGS. 8A-8E are spectra of which the arrival directions are the same.

FIG. 8E shows difference between the graph of FIG. 8C (i.e., the estimated amplitude spectrum of the reference spectrum R) and the graph of FIG. 8D (i.e., the actual measurement of the amplitude spectrum of the reference spectrum R). As shown in the graph E, the estimated value (FIG. 8C), although errors with respect to the actual measurement value (FIG. 8D) in the high-frequency range is increased, as a whole has a value close to the actual measurement value (FIG. 8), and the pattern shapes of peaks or notches are relatively faithfully reproduced. Therefore, it can be said that the amplitude spectrum of the distance to be simulated between the output position of the sound and the collecting position of the sound.

Incidentally, when the number of the impulse responses input from the sound field signal database 18 is one, the generating circuit 22 through-output the reference spectrum input from the FFT circuit 22A (in other words, the actual measurement value of the reference spectrum).

The emphasizing circuit 22C is configured to adjust the reference spectrum R by performing an emphasizing process in which an amplitude component of the amplitude spectrum of the reference spectrum R input from the generation circuit 22B is amplified more as amplitude is larger a particular level, and an amplitude component is attenuated more as an amplitude is lower than the particular level. More specifically, the emphasizing circuit 22C adjusts the reference spectrum R input from the generating circuit 22B by performing the process represented by the following equation (2).

$$V = M exp ( j arg R ) \\ where \\ M = sgn ( D ) \cdot {\vert D \vert}^{1 + β} + sgn ( C ) \cdot {\vert C \vert}^{1 + β} \\ C = [ \vert \sqrt{\overline{{R}_{L}} ∘ {R}_{R}} \vert \vert \sqrt{\overline{{R}_{R}} ∘ {R}_{L}} \vert ] \\ D = \vert R \vert - C \\ β > 0 \qquad ( 2 )$$

For convenience of explanation, the L channel component and the R channel component of the reference spectrum R are referred to as “reference spectrum R_{L}” and “reference spectrum R_{R},” respectively, and the reference spectrum R after adjustment is referred to as “criterion spectrum V.” In the above equation (2), “exp” denotes an exponential function, and “arg” denotes a deflection angle. j is an imaginary unit. “sgn” denotes a signum function. P is a coefficient, and C and D indicate a common component and an independent component of the reference spectrum R_{L} and the reference spectrum R_{R}, respectively. In the above equation (2), a notation of a frequency point is omitted. In practice, the emphasizing circuit 22C obtains the criterion spectrum V by calculating the value V for each frequency point using the above equation (2).

According to the above equation (2), the reference spectrum R is adjusted so that the amplitude component larger than zero (i.e., positive) in a decibel unit increases more and the amplitude component smaller than zero (i.e., negative) in the decibel unit attenuates more while maintaining the phase spectrum. Thus, the level difference on the amplitude spectra forming the peaks and notches of the spectral cue is expanded (in other words, the peaks and the notches of the spectral cue are emphasized).

In the present embodiment, by changing the coefficient β, the degree of emphasis of the peak and the notch of the spectral cue can be adjusted.

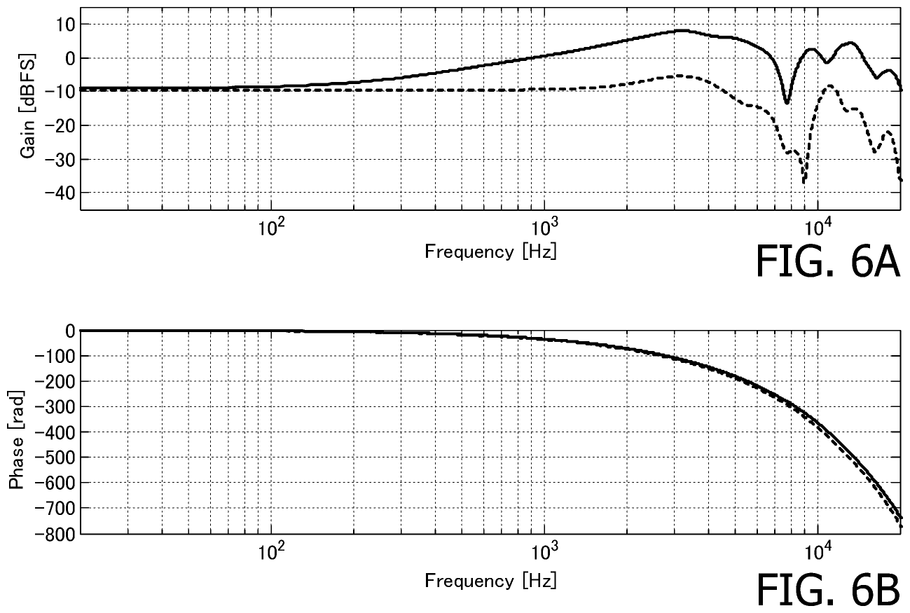

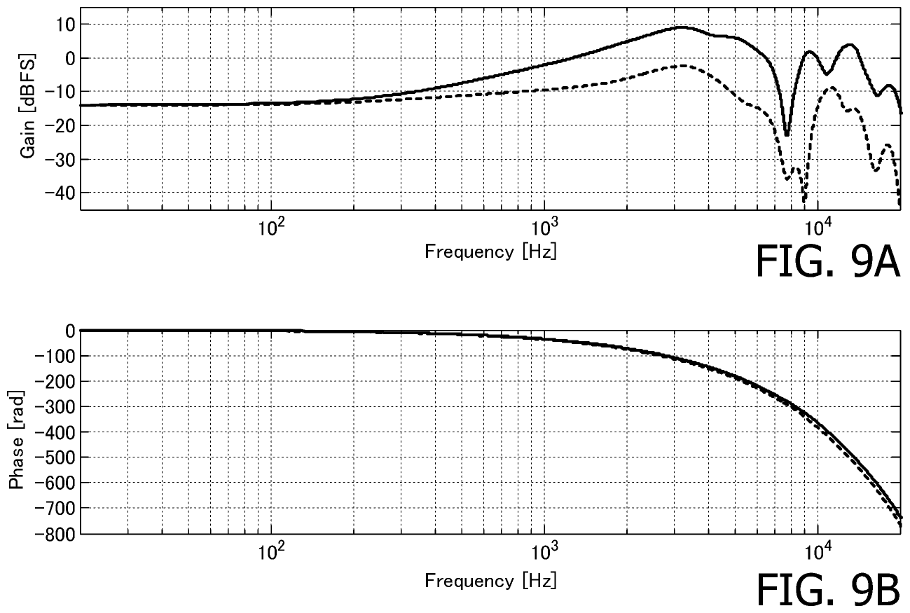

FIGS. 9A-9B shows the criterion spectrum V obtained by adjusting the reference spectrum R shown in FIGS. 6A-6B. FIG. 9A shows the amplitude spectrum and FIG. 9B shows the phase spectrum. The vertical axis of FIG. 9A indicates power (unit: dBFS) and the horizontal axis indicates frequency (unit: Hz). The vertical axis of FIG. 9B indicates phase (unit: rad) and the horizontal axis indicates frequency (unit: Hz). In the example shown in FIGS. 9A-9B, the coefficient β is 0.5. Comparing FIGS. 6A-6B and FIGS. 9A-9B, it can be seen that the processing by the emphasizing circuit 22C enlarged the level difference on the amplitude spectrum forming the peaks and notches mainly appearing in the high frequency range.

As described above, the emphasizing circuit 22C operates as a adjusting circuit for adjusting an acoustic transfer function obtained based on an arrival sound, which is collected by a sound collector, arrived from a direction which forms a particular angle to the sound collector, by applying an emphasizing process to an amplitude spectrum of the acoustic transfer function. The emphasizing process includes more amplifying a component of which an amplitude of the amplitude spectrum is greater than a particular reference level and more attenuating a component of which an amplitude of the amplitude spectrum is less than the particular reference level. In another aspect, the emphasizing circuit 22C operates as a adjusting circuit for adjusting an acoustic transfer function obtained based on an arrival sound, which is collected by a sound collector, arrived from a direction which forms a particular angle to the sound collector, by performing an emphasizing process to emphasize a peak and a notch of a spectral cue represented in an amplitude spectrum of the acoustic transfer function.

The sound image area controller 24 is configured to generate a criterion convolving filter H, by performing different gain adjustment for each frequency band of the criterion spectrum V input from the emphasizing circuit 22C. Specifically, the sound image area controller 24, by performing the process represented by the following equation (3), generates the criterion convolving filter H. In the following equation (3), LPF denotes a low-pass filter, and HPF denotes a high-pass filter. Z, γ, and fc denote a full-scale flat characteristic, a gain factor, and cutoff frequency, respectively. In the present embodiment, the gain factory and the cutoff frequency fc are −30 dB and 500 Hz, respectively.

H(V,f_{c},γ)=γLPF(Z,f_{c})+HPF(V,f_{c}) (3)

As shown in the above equation (3), the sound image area controller 24 is consisted with band dividing filters. As these band dividing filters function as a crossover network, the sound image area controller 24 is configured to satisfy the following equation (4) when the gain factor γ is 1 and the criterion spectrum V is a flat characteristic Z of the full scale. Incidentally, the band dividing filters constituting the sound image area controller 24 are not limited to a low-pass filter and a high-pass filter, and may be another filter (e.g., a bandpass filter).

|H(V,f_{c},γ)|≈|Z| (4)

In the criterion convolving filter H obtained by performing the process shown in the above equation (3) concave-convex shapes appearing in the low frequency range of the criterion spectrum V are substantially lost. In contrast, when the sound image area controller 24 performs the processing shown in the following equation (5) in place of the above equation (3) the criterion convolving filter H, in which the concave-convex shapes appearing in in the low frequency range of the criterion spectrum V is substantially not lost, is obtained.

H(V,f_{c},γ)=γV·LPF(Z,f_{c})+HPF(V,f_{c}) (5)

As described above, the sound image area controller 24 operates as a function control unit that divides the acoustic transfer function adjusted by the adjustment unit (here, the criterion spectrum V input from the emphasizing circuit 22C) into a low-frequency component and a high-frequency component that is a frequency component higher than the low-frequency component, and synthesizes the low-frequency component and the high-frequency component after attenuating the low-frequency component more than the high-frequency component.

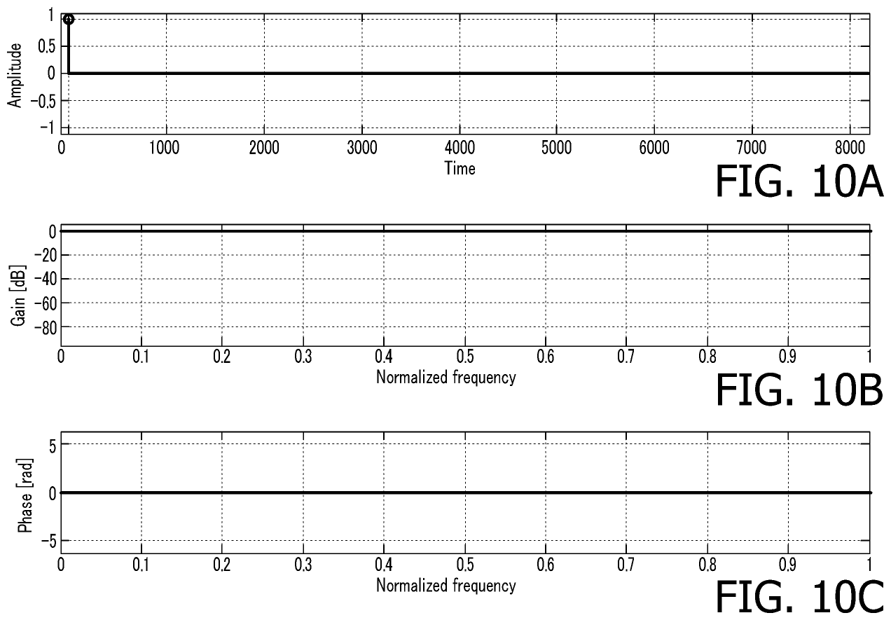

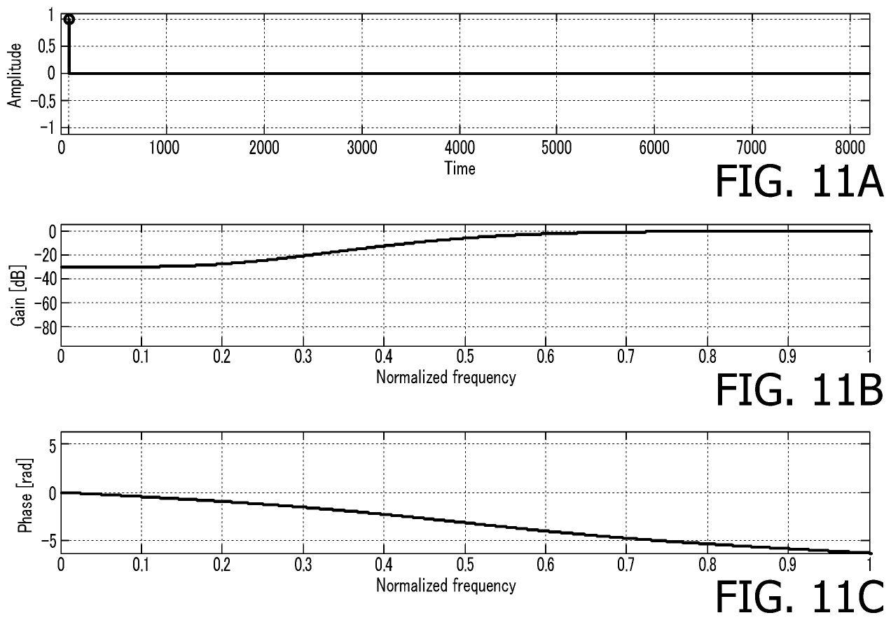

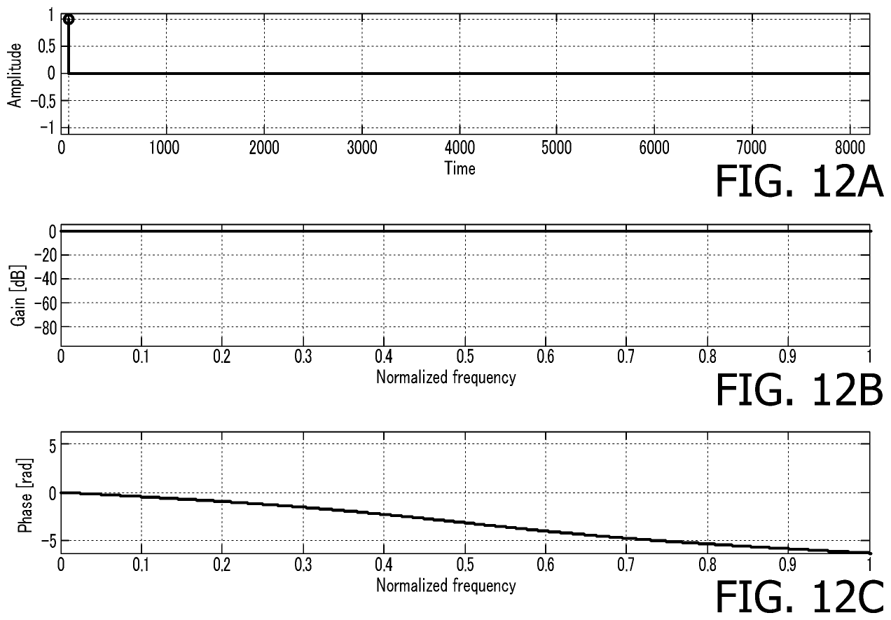

FIGS. 10A-10C show an example of a criterion spectrum V input to the sound image area control section 24. The criterion spectrum V shown in FIGS. 10A-10C is a unit impulse response of 8192 samples. FIGS. 11A-11C and FIGS. 12A-12C show the criterion convolving filter H output by the sound image area control section 24 when the criterion spectrum V shown in FIGS. 10A-10C is input to the sound image area control section 24. Each of FIGS. 10A, 11A and 12A shows a time domain signal, each of FIGS. 10B, 11B and 12B shows an amplitude spectrum and each of FIGS. 10C, 11C and 12C shows a phase spectrum. The vertical axes of FIGS. 10A, 11A and 12A indicate normalized amplitude, and the horizontal axes indicate the time (sample). The vertical axes of FIGS. 10B, 11B and 12B indicate gain (unit: dB), and the horizontal axes indicate normalized frequency. The vertical axes of FIGS. 10C, 11C and 12C indicate phase (unit: rad), and the horizontal axes indicate normalized frequency.

In the example of FIG. 11A-11C, the gain factor γ and the cutoff frequency fc were set to −30 dB and 0.5, respectively. Thus, when setting the gain factor γ and the cutoff frequency fc, the filter characteristic of the sound image area controller 24 has a characteristic of attenuating only the low frequency component.

In the example of FIG. 12A-12C, the gain factor γ and the cutoff frequency fc were set to 0 dB and 0.5, respectively. In this example, the amplitude spectrum is equivalent to the input signal (i.e., the criterion spectrum V shown in FIGS. 10A-10C). In the example of FIGS. 12A-12C, it is understood that the band dividing filter constituting the sound image region controller 24 functions as a crossover network.

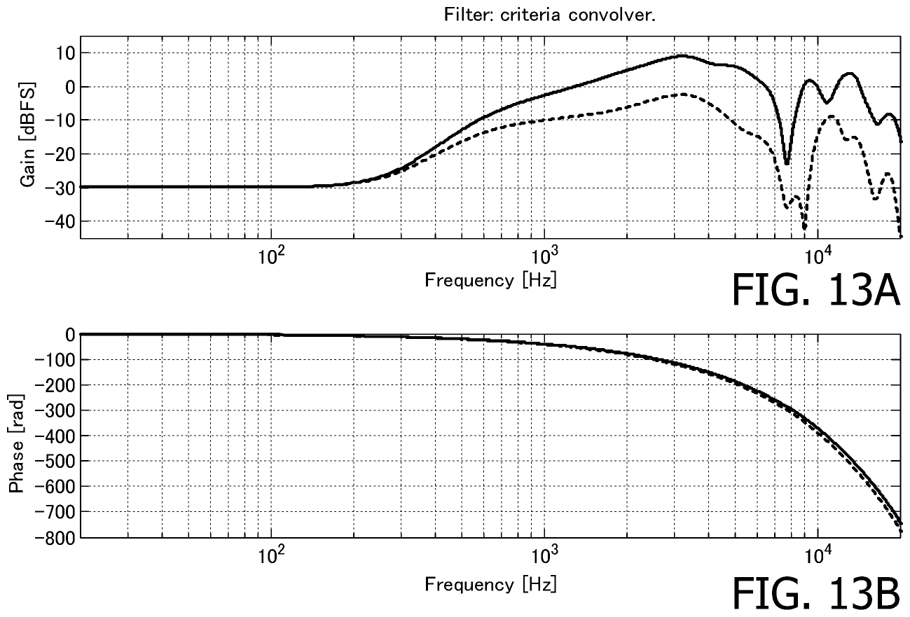

FIGS. 13A-13B show the criterion convolving filter H obtained by gain-adjusting the criterion spectrum V shown in FIG. 9A-9B. FIG. 13A shows the amplitude spectrum and FIG. 13B shows the phase spectrum. The vertical axis of FIG. 13A indicates power (unit: dBFS), the horizontal axis indicates frequency (unit: Hz). The vertical axis of FIG. 13B indicates phase (unit: md) the horizontal axis indicates frequency (unit: Hz). In the example of FIGS. 13A-13B, while the low frequency range is attenuated with respect to the criterion spectrum V shown in FIGS. 9A-9B, the high frequency range is not attenuated, and the criterion convolving filter H shown in FIGS. 13-13 is almost the same as the criterion spectrum V shown in FIGS. 9A-9B.

As can be seen from the graph of each distance (“0.25 m”, “0.50 m”, or “1.00 m”) shown in FIGS. 8A-8C, the longer the distance between the sound output position and the sound collecting position is, the more the level of low frequency range is attenuated. In the present embodiment, by setting degree of attenuation of the low frequency range by changing the gain factor γ and the cutoff frequency fc, it is possible to adjust the distance feeling (i.e., distance from the listener to the output position of the sound) of the sound to be applied to the audio signal.

By the criterion convolving filter H thus generated being convolved into the input spectrum X, the criterion convolved spectrum Y, to which information on the arrival direction of the sound to be simulated (and/or the distance from the output position of the sound to be simulated) is added, is obtained. That is, the multiplying circuit 14 operates as a processing circuit that adds information on the arrival direction of the sound (and/or the distance from the output position of the sound) to the input spectrum X based on the criterion convolving filter H which is the acoustic transfer function.

In the present embodiment by emphasizing the spectral cues, even when a phase shift in the high frequency range or a non-linear phase shift on the frequency axis occurs in the phase spectrum, the notch pattern and the peak pattern of the spectral cues are not completely collapsed (in other words, the shapes of the notch pattern and the peak pattern are maintained). Therefore, for example, even in a listening environment where the listener listens sound output from a pair of speakers arranged behind his/her head, the listener can sense desired sound image localization.

The above is a description of exemplary embodiments of the present disclosures. It is noted that the embodiments of the present disclosures are not limited to those described above, and various adjustments can be made within the scope of the technical idea of the present disclosures. For example, appropriate combination of examples exemplarily described in the specification, obvious examples and the like is included in the embodiments of the present application.

For example, the FFT circuit 12 may perform an overlapping process and a weighting process using a window function with respect to the input signal x, and convert the input signal x, to which the overlapping process and the weighting process using the window function are applied, from a time domain signal to a frequency domain signal by Fourier transform processing. The IFFT circuit 16 may convert the criterion convolved spectrum Y from the frequency domain to the time domain by the inverse Fourier transform processing and perform an overlapping process and a weighting process using a window function.

The value of β in the above equation (2) is not limited to that described in the above embodiment. The value of β of the above equation (2) may be other values, for example, −1<β≤1.

As an application example of the above equation (2), the following can be considered. When the value of β is replaced with β=−1 in the above equation (2), a criterion spectrum V having a flat characteristic can be obtained. In addition, when the value of β is replaced with β<−1 in the above equation (2), a criterion spectrum V in which the spectrum shape is inverted with respect to the criterion spectrum V obtained in the case of −1<β can be obtained.

Various processes in the audio signal processing apparatus 1 are executed by cooperation of software and hardware provided in the audio signal processing apparatus 1. At least an OS part of the software provided in the audio signal processing apparatus 1 is provided as an embedded system, but other parts, for example, a software module for performing processing for emphasizing the peaks and notches of the spectral cues may be provided as an application which can be distributed on a network or stored in a recording medium such as a memory card.

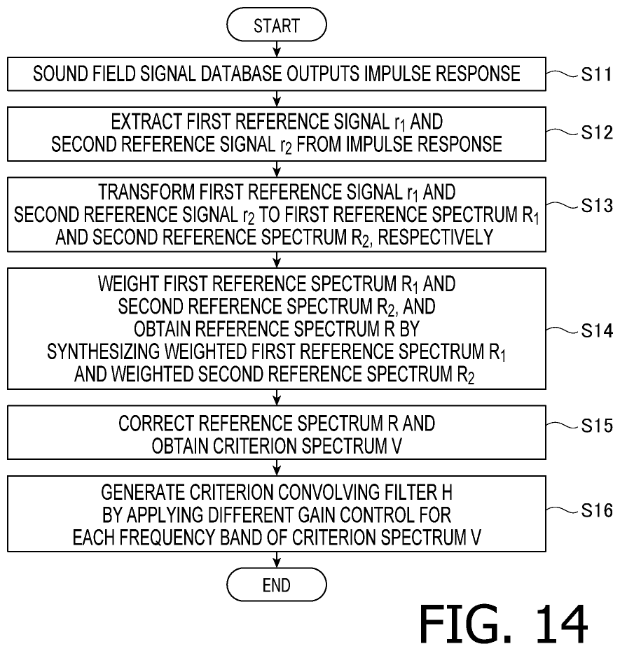

FIG. 14 shows a flowchart illustrating processes performed by the system controller 26 using such a software module or application.

As shown in FIG. 14, the sound field signal database 18 outputs at least one impulse response based on the meta information included in the input signal x (step S11). The reference information extracting circuit 20 extracts a first reference signal r₁ and a second reference signal r₂ for extracting peaks and notches, which are spectral cues, from the impulse responses inputted from the sound field signal database 18 (step S12). The FFT circuit 22A converts the first reference signal r₁ and the second reference signal r₂, which are time domain signals inputted from the reference information extracting circuit 20, into a first reference spectrum R₁ and a second reference spectrum R₂, which are frequency domain signals, respectively, by Fourier transform processing (step S13). The generating circuit 22B obtains the reference spectrum R by weighting each of the first reference spectrum R₁ and the second reference spectrum R₂ input from the FFT circuit 22A and synthesizing the weighted first reference spectrum R₁ and the weighted second reference spectrum R₂ (step S14). The emphasizing circuit 22C adjusts the reference spectrum R to obtain the criterion spectrum V by performing an emphasizing process in which amplitude of the amplitude spectrum of the reference spectrum R input from the generation circuit 22B is amplified more as the amplitude component is larger than a particular level, and the amplitude is attenuated more as the amplitude component is lower than the particular level (step S15). The sound image area controller 24 generates the criterion convolving filter H by performing different gain control for each frequency band with respect to the criterion spectrum V input from the emphasizing circuit 22C (step S16). In the multiplying circuit 14, the criterion convolving filter H is convolved into the input spectrum X, thereby the criterion convolved spectrum Y to which information on the arrival direction of the sound (and the distance to the output position of the sound) is added is obtained.

What is claimed is:

1. An audio signal processing apparatus configured to process an audio signal comprising:
a adjusting circuit configured to adjust an acoustic transfer function obtained based on an arrival sound, which is collected by a sound collector, arrived from a direction which forms a particular angle to the sound collector, the adjusting circuit adjusting the acoustic transfer function by applying an emphasizing process to an amplitude spectrum of the acoustic transfer function, the emphasizing process including amplifying an amplitude component of the amplitude spectrum more as an amplitude is greater than a particular reference level and attenuating the amplitude component of the amplitude spectrum more as the amplitude is smaller than the particular reference level; and
a processing circuit configured to add, to the audio signal, information indicating an arrival direction of a sound based on the acoustic transfer function adjusted by the adjusting circuit.

2. The audio signal processing apparatus according to claim 1, further comprising a function controlling circuit configured to divide the acoustic transfer function adjusted by the adjusting circuit into a low frequency component and a high frequency component which is a component of higher frequency than the low frequency component, attenuate the low frequency component more than the high frequency component, and synthesize the low frequency component and the high frequency component after attenuating the low frequency component.

3. The audio signal processing apparatus according to claim 1, further comprising:
a storing part configure to store impulse response of the arrival sound; and
an obtaining part configured to obtain, from the impulse, response the acoustic transfer function including a spectral cue,
wherein the adjusting circuit enlarges level difference between a peak and a notch of the spectral cue by applying the emphasizing process to the amplitude spectrum of the acoustic transfer function obtained by the obtaining circuit.

4. The audio signal processing apparatus according to claim 3, further comprising:
wherein the storing part stores multiple pieces of impulse response of multiple arrival sounds, each of which has a different arrival direction,
wherein the obtaining circuit performs:
obtaining at least two acoustic transfer functions from at least two pieces of impulse response among the multiple pieces of impulse responses;
weighting the at least two acoustic transfer functions; and
synthesizing the at least two acoustic transfer functions after weighting the at least two acoustic transfer functions.

5. The audio signal processing apparatus according to claim 3,
wherein the storing part stores multiple pieces of impulse response of multiple arrival sounds, a distance of each of which between an outputting position of each arrival sound and the sound collector being different,
wherein the obtaining circuit performs:
obtaining at least two acoustic transfer functions from at least two pieces of impulse response among the multiple pieces of impulse responses;
weighting the at least two acoustic transfer functions; and
synthesizing the at least two acoustic transfer functions after weighting the at least two acoustic transfer functions.

6. The audio signal processing apparatus according to claim 3, further comprising a transforming circuit configured to apply Fourier transform to the audio signal,
wherein the obtaining circuit obtains the acoustic transfer function by applying Fourier transform to impulse response of the arrival sound, and
wherein the processing circuit performs:
convolving the acoustic transfer function adjusted by the adjusting circuit into the audio signal, to which Fourier transform is applied; and
obtaining an audio signal, to which information indicating an arrival direction is added, by performing inverse Fourier transform to the convolved audio signal.

7. An audio signal processing apparatus configured to process an audio signal comprising:
a adjusting circuit configured to adjust an acoustic transfer function obtained based on an arrival sound, which is collected by a sound collector, arrived from a direction which forms a particular angle to the sound collector, the adjusting circuit adjusting the acoustic transfer function by emphasizing a peak and a notch of a spectral cue represented in an amplitude spectrum of the acoustic transfer function; and
a processing circuit configured to add, to the audio signal, information indicating an arrival direction of a sound based on the acoustic transfer function adjusted by the adjusting circuit.

8. An audio signal processing method for an audio signal processing apparatus configured to process an audio signal, including:
adjusting an acoustic transfer function obtained based on an arrival sound, which is collected by a sound collector, arrived from a direction which forms a particular angle to the sound collector, the acoustic transfer function being adjusted by applying an emphasizing process to an amplitude spectrum of the acoustic transfer function, the emphasizing process including amplifying an amplitude component of the amplitude spectrum more as an amplitude is greater than a particular reference level and attenuating the amplitude component of the amplitude spectrum more as the amplitude is smaller than the particular reference level; and
adding, to the audio signal, information indicating an arrival direction of a sound based on the adjusted acoustic transfer function.

9. A non-transitory computer recording medium for causing an audio signal processing apparatus, the recording medium containing computer-executable programs causing, when executed by a computer, the audio signal processing apparatus to perform the audio signal processing method according to claim 8.
